(19) United States
(12) Patent Application Publication
(10) Pub. No.: US 2018/0177172 A1
(43) Pub. Date: Jun. 28, 2018

(54) FISHING ROD BUTT CAP WITH INTEGRATED ROD TIP HOLDER

(71) Applicant: Pure Fishing, Inc., Spirit Lake, IA (US)

(72) Inventors: Mark Talwin, Lexington, SC (US); Joaquim da Rosa, Lexington, SC (US); Cameron Ivie, Irmo, SC (US)

(21) Appl. No.: 15/390,945

(22) Filed: Dec. 27, 2016

(51) Int. Cl. A01K 87/02

(52) U.S. Cl. CPC A01K 87/02

(57) ABSTRACT

A fishing rod butt cap for use on one end portion of a multi-piece fishing rod having a base section and a rod tip section, the butt cap including an elastic member attached to the butt cap and stretchable so as to overlay and engage the rod tip when the rod tip section is positioned along the length of the base section. The butt cap may also include a slot for receiving the elastic member when not in use, and an additional opening for allowing a user to grasp the elastic member when stored in the slot. An additional elastic member is attached between the joining end portions of the base section and rod tip section for securing those end portions of the fishing rod when the rod tip section is stored along the length of the base section.

### BACKGROUND OF THE INVENTION

The present invention relates generally to a fishing rod mechanism for holding the rod tip associated with a fishing rod assembly in a storage/transportation position and, more particularly, to a fishing rod butt cap mechanism for securing the rod tip to the base section of the fishing rod during storage and/or transportation.

Many fishing rods come in multiple-piece rod sections wherein one rod section is easily engageable with another rod section in order to complete the assembly of fishing rod. More particularly, many typical fishing rods include a two-piece rod assembly, namely, a base section and a top section which includes the rod tip. Typically, one end portion of the base section includes cooperatively engageable means for receiving one end portion of the top section of the fishing rod. This joinder is typically called a ferrule joint and includes a male ferrule and a female ferrule. Typically, the base section of the fishing rod will include the female ferrule while the rod tip section typically includes the male ferrule, or vice versa. This type of ferrule is typically called a sleeve-over ferrule wherein one section slides over the tip of another section.

Typically, during storage or transportation of the fishing rod, the multiple-piece rod sections are disengaged and the separate components are typically stored or carried either (1) in a tubular sleeve member which is bulky and cumbersome, or (2) the multiple-piece sections are transported individually which could contribute to damage or loss of one or both sections of the fishing rod.

It is therefore desirable to enable anglers or other users of fishing rods to easily secure the fishing rod tip to the base section of the fishing rod while transporting the rod assembly from one location to another. It is also desirable to allow a user to store a multiple-piece rod assembly in one system.

Accordingly, the present invention is directed to a fishing rod butt cap mechanism which will allow a user or angler to store and transport a multiple-piece fishing rod in one assembly.

### SUMMARY OF THE INVENTION

The present application teaches the construction and operation of a fishing rod butt cap mechanism which enables anglers to easily secure the fishing rod tip section to the base section of the fishing rod while transporting the rod assembly. The fishing rod butt cap includes an elastic member or bungee type cord which allows the tip of the fishing rod to be stored along the length of the base section of the rod. In this regard, the butt cap may include a groove or slot for receiving the elastic member when not in use. The opposite end portions of the elastic member are attached or otherwise joined to the butt cap in a conventional manner such as through the use of mechanical fasteners, adhesives, sonic welding, or other appropriate means for firmly attaching the elastic member to the butt cap. When the rod tip section of the fishing rod is disengaged from the base section and positioned along the length of the base section with the rod tip at the butt cap, the elastic member associated with butt cap is simply pulled over the rod tip so as to secure the rod tip to the butt cap of the fishing rod.

An additional elastic member or bungee type cord is associated with the ferrule joint and is assembled such that one end portion thereof is securely attached to the female ferrule associated with the base section and has its opposite end portion securely attached to the male ferrule associated with the rod tip section. This elastic member should be of sufficient length so as to allow the rod tip section to be disengaged from the base section and folder over lengthwise so as to be stored along the length of the base section. This additional elastic member holds the opposite end portions of the tip section and base section together when the elastic member associated with the butt cap is positioned over the fishing rod tip for storage and/or transportation.

These and other objects and advantages of the present invention will become a parent to those skilled in the art after consideration of the following specification taken in conjunction with the accompanying drawings.

### BRIEF DESCRIPTION OF THE DRAWINGS

For a better understanding of the present invention, reference may be made to the accompanying drawings.

FIG. 1 is a perspective view of one embodiment of the present fishing rod butt cap mechanism showing the fishing rod in its assembled condition.

FIG. 2 is a perspective view similar to FIG. 1 showing the present fishing rod in its disassembled condition prior to folding the rod tip section along the length of the base section.

FIG. 3 is a perspective view of the present fishing rod wherein the rod tip section is stored along the length of the base section and the elastic member associated with the butt cap is positioned over the rod tip.

FIG. 4 is a partial perspective view of the butt cap associated with the present fishing rod without the elastic member attached thereto.

FIG. 5 is an end elevational view of the present fishing rod butt cap with the elastic member stored within the butt cap.

FIG. 6 is a partial side elevational view of the butt cap showing the elastic member engaged with the rod tip of the present fishing rod.

FIG. 7 is an enlarged partial perspective view of the joinder end portions of the base section and rod tip section of the fishing rod showing the elastic member attached respectively thereto.

### DETAILED DESCRIPTION OF THE INVENTION

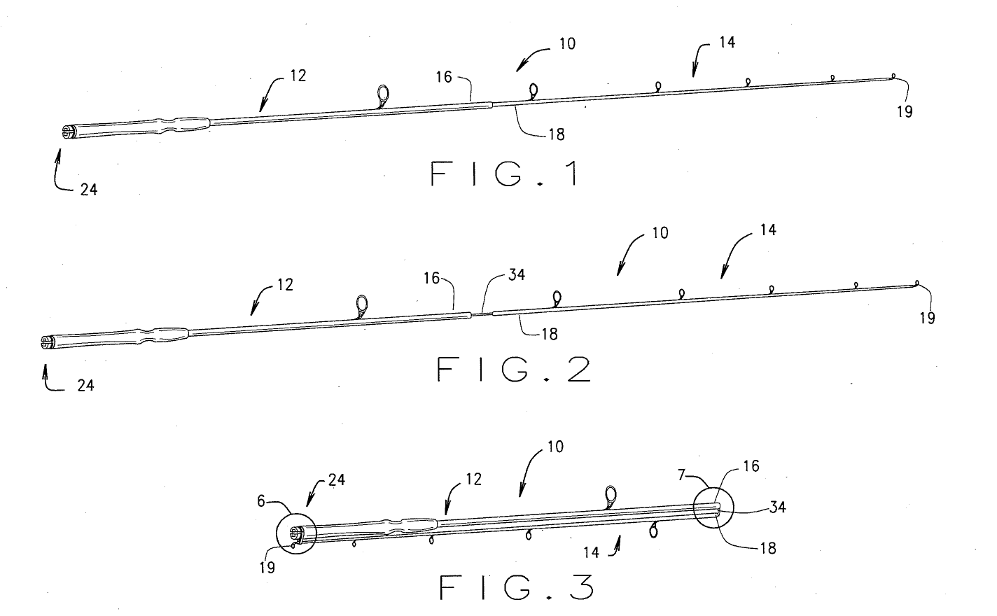

Referring to the drawings more particularly by reference numbers wherein like numerals refer to like parts, number 10 in FIG. 1 illustrates a two-piece fishing rod incorporating the new butt cap mechanism for securing the fishing rod tip to the base section of the fishing rod as will be hereinafter further explained. The fishing rod 10 includes a base section 12 and a top section or rod tip section 14 joined together in a conventional manner as illustrated in FIG. 1. The base section 12 includes a butt cap 24 at one end portion thereof and an opposite end portion 16 whereas the rod tip section includes an end portion 18 and an opposite tip end 19. The joinder mechanism between rod sections 12 and 14 typically includes a conventional ferrule joint wherein one end portion 16 of the base section 12 cooperatively engages one end portion 18 of the rod tip section 14. In this regard, the base section end portion 16 may include a female ferrule or cavity 20 as best illustrated in FIG. 7 and end portion 18 associated with the rod tip section may include the male ferrule 22 for insertion into the cavity 20. The male ferrule 22 may likewise be slightly tapered so as to ensure a tight frictional fit between the relative end portions 16 and 18. Also, the cavity 20 should be sufficiently deep to sufficiently receive the male ferrule 22 and still have enough strength to withstand flexing. It is also recognized and anticipated that the male and female ferrules could be reversed such that the cavity 20 could be associated with the rod tip section end portion 18 and the male ferrule 22 could be associated with the base section end portion 16. Other conventional means for interconnecting the rod tip section 14 with the base section 12 are likewise envisioned and anticipated.

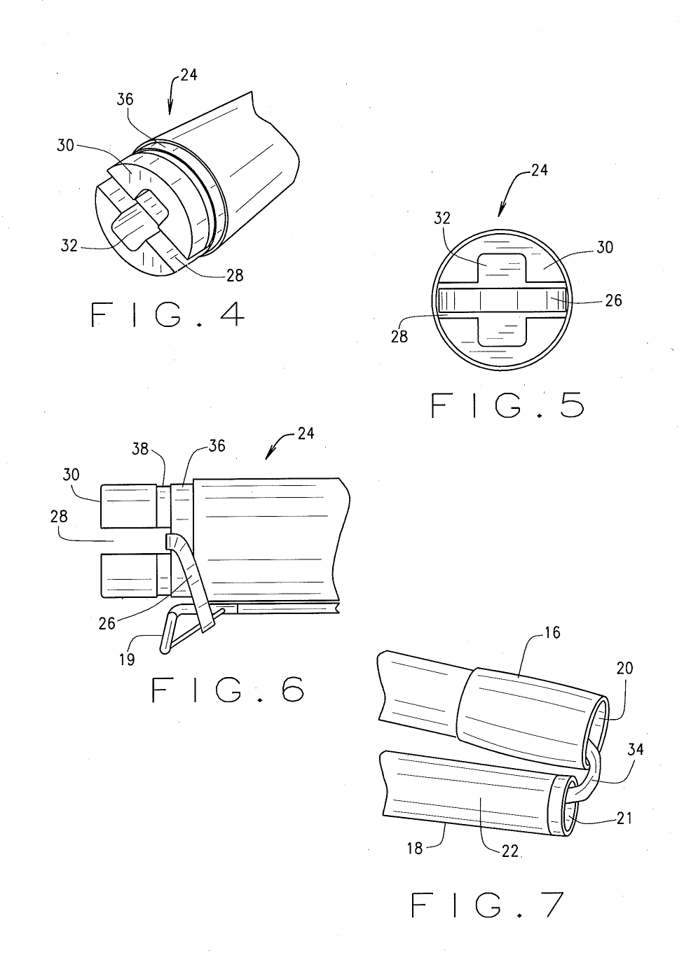

The butt cap 24 associated with the one end portion of the base section 112 as best illustrated in FIGS. 4-6 includes an elastic member or bungee type cord 26 which can be attached to the butt cap 24 in any conventional manner such as through the use of mechanical fasteners, sonic welding, adhesive or other conventional means for attaching the opposite end portion of the elastic member 26 to the butt cap 24. Butt cap 24 may also include a slot or groove 28 for receiving the elastic member 26 therewithin when the elastic member 26 is not in use and is in its unstretched condition. Although not necessary, the slot or groove 28 allows the elastic member to be stored therewithin so as to avoid fraying and/or additional wear and tear if the elastic member 26 is exposed adjacent the butt cap surface 30 during normal use. An additional slot or opening 32 may likewise be provided in association with the slot or groove 28 so as to provide sufficient space for a user to easily grasp the elastic member 26 when stored within the slot 28 so as to pull the elastic member 26 out of the slot for engaging the rod tip 19 as illustrated in FIG. 6. Opening 32 may take on any convenient shape and/or configuration and may be oriented somewhat perpendicular to slot 28 so as to provide additional space for allowing the user to easily grasp the elastic member 26 when stored within the slot 28. It is also recognized and anticipated that slot 28 and opening 32 could be formed as one opening or slot.

An additional or second elastic member or bungee cord 34 as best illustrated in FIGS. 2 and 7 is assembled inside the respective end portions 16 and 18 of base section 12 and rod tip section 14 so as to both allow the rod tip section 14 to be moved and stored along the length of the base section 12 as best illustrated in FIG. 3, and to likewise hold and secure the respective rod end portions 16 and 18 when rod tip section 14 is moved to its storage position. In this regard, one end portion of the second elastic member 34 is attached within the cavity 20 associated with base end portion 16 and the opposite end portion of the elastic member 34 can be attached in a cavity 21 associated with rod tip end portion 18. Other attachment mechanisms are likewise recognized and envisioned. The elastic member 34 should be of sufficient length and stretchability so as to allow the rod tip section 14 to be easily engaged and disengaged with the base section 12 and to allow the respective rod end portion 16 and 18 to be placed in a parallel position when the rod tip section 14 is placed in its storage or transportation position along the length of base section 12 as illustrated in FIG. 3.

In use, an angler or other user will disengage the rod tip section 14 from the base section 12 by separating the rod end portions 16 and 18 as best shown in FIG. 2. Once rod tip section 14 is disengaged from base section 12, the rod tip section 14 is moved to a parallel position along the length of the base section as best shown in FIG. 3 and the elastic member 26 associated with butt cap 24 is stretched so as to overlay the rod tip 19 as best illustrated in FIG. 6. The elastic member 26 allows the tip 19 of the fishing rod to be held in position adjacent thereto along the length of the base section 12 so that the entire fishing rod 10 including its base section 12 and rod tip section 14 can be easily stored and transported in one assembly from one location to another. Elastic member 34 likewise holds the adjacent rod end portions 16 and 18 in a secure position when the rod tip 19 is engaged with the butt cap 24. When ready for use, the elastic member 26 is simply removed from the rod tip 19 and the rod tip section 14 is engaged with the base section 12 as previously explained.

As previously stated, it is recognized and anticipated that any conventional means for joining the rod tip section 14 to the base section 12 can be utilized so long as an elastic member such as second elastic member 34, or an equivalent mechanism, can be attached to the respective end portions 16 and 18 so as to further secure the end portions 16 and 18 when the fishing rod 10 is placed in its storage or transportation position. It is also recognized and anticipated that the butt cap 24 can take on a wide variety of different shapes and configurations, and that the slots 28 and 32 are optional. In this regard, the slots 28 and 32 can likewise take on a wide variety of different shapes and configurations for storing the elastic member 26 and allowing easy grasping thereof when the elastic member 26 is needed for securely holding the rod tip 19 as illustrated in FIG. 6. It is also recognized and anticipated that other storage means for storing the elastic member 26 when not in use may likewise be utilized. For example, the elastic member 26 can likewise be stored adjacent at least a portion of the outer periphery of the butt cap 24 along a portion of surface portion 36, or along another butt cap surface portion if the slots 28 and/or 32 are not utilized. In addition, an indentation or groove such as groove 38 or the indentation associated with surface portion 36 could be formed in at least a portion of the outer periphery of the butt cap to likewise store the elastic member 26 when not in use. Other variations and modifications to the various components comprising the present fishing rod butt cap with integrated rod tip holder are likewise envisioned and contemplated.

Thus, there has been shown and described a novel fishing rod butt cap which is adaptable for use on a wide variety of different multi-piece fishing rods, which fishing rod butt cap includes the integrated rod tip holder 26 as explained above. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present invention will, however, become apparent to those skilled in the art after considering the present specification and the accompanying drawings. All such changes, modifications, variations and other uses and applications, which do not depart from the spirit and scope of the present invention are deemed to be covered by the invention which is limited only by the claims which follow.

What is claimed is:

1. A fishing rod butt cap for use on one end of a multi-piece fishing rod having a base section and a rod tip section, the rod tip section having a rod tip, the butt cap comprising an elastic member having opposite end portions attached to the butt cap, the elastic member being stretchable so as to overlay and engage the rod tip when the rod tip section is positioned along the length of the base section.

2. The fishing rod butt cap defined in claim 1 wherein the elastic member is integrally formed with the butt cap.

3. The fishing rod butt cap defined in claim 1 including a slot formed in the butt cap for receiving the elastic member when not in use.

4. The fishing rod butt cap defined in claim 3 including an additional opening for allowing a user to grasp the elastic member when stored in said slot.

5. The fishing rod butt cap defined in claim 1 wherein the butt cap includes an outer periphery, the elastic member being stored along at least a portion of the outer periphery of said butt cap when not in use.

6. A base section of a multi-piece fishing rod comprising:
a butt cap located at one end portion of said base section, said butt cap having an elastic member attached thereto, said elastic member being stretchable so as to engage a rod tip associated with another section of the multi-piece fishing rod when the rod tip is positioned along the length of the base section;
the opposite end portion of said base section including a cooperatively engageable mechanism for engaging one end portion of the another section of the multi-piece fishing rod.

7. The base section defined in claim 6 wherein said butt cap includes an outer periphery, the elastic member being stored along at least a portion of the outer periphery of said butt cap when not in use.

8. The base section defined in claim 6 wherein said butt cap includes a groove for receiving the elastic member when not in use.

9. The base section defined in claim 8 including an additional opening for allowing a user to grasp the elastic member when stored in said slot.

10. The base section defined in claim 9 wherein said additional opening is positioned perpendicular to said slot.

11. A multi-piece fishing rod comprising:
a base section and a rod tip section;
said base section including a butt cap associated with one end portion thereof and a joinder mechanism associated with its opposite end portion;
said rod tip section including a rod tip associated with one end portion thereof and a joinder mechanism associated with its opposite end portion for cooperatively engaging the joinder mechanism associated with said base section;
said butt cap including a slot associated therewith, and an elastic member attached to said butt cap, said elastic member being receivable within said slot when not in use, said elastic member being stretchable so as to engage the rod tip associated with said rod tip section when said rod tip section in positioned along the length of said base section for transportation and/or storage.

12. The multi-piece fishing rod defined in claim 11 including an additional opening associated with said butt cap for allowing a user to grasp the elastic member when stored in said slot.

13. The multi-piece fishing rod defined in claim 11 including a second elastic member having opposite end portions, one end portion of said second elastic member being attached to the opposite end portion of said base section, and having its opposite end portion attached to the opposite end portion of said rod tip section.

14. The multi-piece fishing rod defined in claim 13 wherein said second elastic member is stretchable so as to allow the rod tip section to be positioned along the length of said base section.
